(19) United States
(12) Patent Application Publication
(10) Pub. No.: US 2026/0340401 A1
(43) Pub. Date: Oct. 29, 2026

(54) OPTIMIZING TRAINING OF MACHINE LEARNING MODELS WITH RELABELED ENTITIES

(71) Applicant: NEC Laboratories America, Inc., Princeton, NJ (US)

(72) Inventors: Sparsh Garg, Fremont, CA (US); Abhishek Aich, San Jose, CA (US)

(21) Appl. No.: 19/655,181

(22) Filed: Apr. 22, 2026

Related U.S. Application Data
(60) Provisional application No. 63/795,858, filed on Apr. 28, 2025.
(60) Provisional application No. 63/802,871, filed on May 9, 2025.
(60) Provisional application No. 63/824,297, filed on Jun. 16, 2025.
(60) Provisional application No. 63/824,298, filed on Jun. 16, 2025.

(51) Int. Cl. G06N 3/0895; G06V 10/25; G06V 20/70

(52) U.S. Cl. CPC G06N 3/0895; G06V 10/25; G06V 20/70

(57) ABSTRACT

Systems and methods for optimizing training of machine learning models with relabeled entities. Bounding boxes of detected entities within a scene obtained from images can be generated with an open vocabulary model. Entity masks for the detected entities can be generated based on pixel-wise information of the detected entities obtained within the bounding boxes with a segmentation model. Fine-grained labels for the detected entities can be determined based on filtered pixel-wise information of the detected entities from the entity masks and learned knowledge of fine-grained categories. An augmented dataset can be generated with the fine-grained labels and the entity masks to retrain a machine learning model to perform downstream tasks.

### RELATED APPLICATION INFORMATION

This application claims priority to U.S. Provisional App. No. 63/795,858, filed on Apr. 28, 2025, to U.S. Provisional App. No. 63/802,871, filed on May 9, 2025, to U.S. Provisional App. No. 63/824,297, filed on June 16, 2025, and to U.S. Provisional App. No. 63/824,298, filed on June 16, 2025, incorporated herein by reference in their entirety. This application is related to an application entitled “OPTIMIZING TRAINING OF MACHINE LEARNING MODELS WITH FINE-GRAINED LABELS”, having attorney docket number 25005, and which is incorporated by reference herein in its entirety.

### BACKGROUND

### Technical Field

The present invention relates to training machine learning model, and more particularly to optimizing training of machine learning models with relabeled entities.

### Description of the Related Art

Autonomous driving systems rely heavily on large-scale, diverse, and precisely annotated datasets to achieve high performance perception and decision-making capabilities. The capabilities of autonomous driving systems are proportional to the quality of training datasets that they utilize to train. The higher the quality of training data, the higher quality of predictions the autonomous driving systems can generate.

### SUMMARY

According to an aspect of the present invention, a method is provided, including, generating bounding boxes of detected entities within a scene obtained from images with an open vocabulary model, generating entity masks for the detected entities based on pixel-wise information of the detected entities obtained within the bounding boxes with a segmentation model, determining fine-grained labels for the detected entities based on filtered pixel-wise information of the detected entities from the entity masks and learned knowledge of fine-grained categories, and generating an augmented dataset with the fine-grained labels and the entity masks to retrain a machine learning model to perform downstream tasks.

According to another aspect of the present invention, a system is provided, including, a memory device, and one or more processor devices operatively coupled with the memory device to perform operations including, generating bounding boxes of detected entities within a scene obtained from images with an open vocabulary model, generating entity masks for the detected entities based on pixel-wise information of the detected entities obtained within the bounding boxes with a segmentation model, determining fine-grained labels for the detected entities based on filtered pixel-wise information of the detected entities from the entity masks and learned knowledge of fine-grained categories, and generating an augmented dataset with the fine-grained labels and the entity masks to retrain a machine learning model to perform downstream tasks.

According to yet another aspect of the present invention, a non-transitory computer program product is provided including a computer-readable storage medium including a program code, wherein the program code when executed on a computer causes the computer to perform operations including, generating bounding boxes of detected entities within a scene obtained from images with an open vocabulary model, generating entity masks for the detected entities based on pixel-wise information of the detected entities obtained within the bounding boxes with a segmentation model, determining fine-grained labels for the detected entities based on filtered pixel-wise information of the detected entities from the entity masks and learned knowledge of fine-grained categories, and generating an augmented dataset with the fine-grained labels and the entity masks to retrain a machine learning model to perform downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for optimizing training of machine learning models with relabeled entities, in accordance with an embodiment of the present invention;

FIG. 2 is a block diagram that shows a computer system for optimizing training of machine learning models with relabeled entities, in accordance with an embodiment of the present invention;

FIG. 3 is a block diagram that shows components of a computer system for optimizing training of machine learning models with relabeled entities, in accordance with an embodiment of the present invention;

FIG. 4 is a block diagram that shows entities within a scene that are captured with a bounding box, clipped entity, and an entity mask for optimizing training of machine learning models with relabeled entities, in accordance with an embodiment of the present invention;

FIG. 5 is a flow diagram that shows a high-level overview of optimizing training of machine learning models with relabeled entities, in accordance with an embodiment of the present invention; and

FIG. 6 is a block diagram that shows a practical application involving autonomous vehicles for optimizing training of machine learning models with relabeled entities, in accordance with an embodiment of the present invention.

### DETAILED DESCRIPTION OF PREFERRED EMBODIMENTS

In accordance with embodiments of the present invention, systems and methods are provided for optimizing training of machine learning models with relabeled entities.

In the present embodiments, bounding boxes of detected entities within a scene obtained from images can be generated with an open vocabulary model. Entity masks for the detected entities can be generated based on pixel-wise information of the detected entities obtained within the bounding boxes with a segmentation model. Fine-grained labels for the detected entities can be determined based on filtered pixel-wise information of the detected entities from the entity masks and learned knowledge of fine-grained categories. An augmented dataset can be generated with the fine-grained labels and the entity masks to retrain a machine learning model to perform downstream tasks.

Autonomous driving systems rely heavily on large-scale, diverse, and precisely annotated datasets to achieve high performance perception and decision-making capabilities. However, labeling such datasets— especially with fine-grained annotations—is both time consuming and expensive. This challenge is further amplified in real-world scenarios where objects like traffic signs, pedestrians, or vehicles often require detailed semantic distinctions. For instance, while existing open-source datasets annotate traffic signs as a coarse category, self-driving models can distinguish between a stop sign, speed limit sign, or yield sign to make context-aware driving decisions. The gap between coarse annotations and the fine-grained labels for safe and effective autonomy presents a major bottleneck in scalable dataset development.

Accurate annotations are utilized for training perception models in autonomous vehicles, particularly when dealing with complex urban environments. Large-scale datasets have provided training resources, yet many of these annotations remain coarse or ambiguous, especially for categories like traffic signs and pedestrian signals. Fine-grained labeling remains prohibitively expensive.

Vision-language models (VLMs) have shown strong potential in aligning visual content with rich textual semantics, offering a promising direction for reducing annotation efforts. Recent models incorporate large-scale vision-text pretraining and multimodal alignment, enabling zero-shot and prompt-based image understanding across open vocabulary categories.

Despite these advances, current VLMs still exhibit notable limitations when applied to fine-grained relabeling tasks in autonomous driving. Specifically, they often fail to recognize small, distant, or occluded objects such as traffic signs and pedestrian symbols—categories utilized for safety in driving systems. Additionally, obtaining accurate predictions frequently requires extensive prompt engineering and iterative query tuning, which introduces complexity and instability into the pipeline. This dependence on carefully curated prompts is time-consuming and difficult to scale across large datasets with varying visual contexts. Moreover, the large model sizes and inference costs associated with VLMs pose practical challenges when deploying these systems at scale, particularly in resource-constrained environments.

Recent advances in open-source detection and segmentation models have significantly lowered the barrier for automatic image annotation or relabel them. Segmentation models can generate high-quality bounding boxes and segmentation masks with minimal supervision. These models are particularly attractive for auto labeling pipelines, as they generalize well across diverse visual concepts and support open vocabulary queries or prompts.

Despite their strengths, these models often struggle with recognizing objects in complex real-world scenarios, particularly in the context of autonomous driving. Objects that are small, far from the camera, truncated, or occluded—such as distant traffic signs or partially visible vehicles—are frequently missed or misclassified. While segmentation models excels at generating precise masks, it lacks semantic understanding and can be combined with additional classifiers or VLMs to assign labels. Similarly, open vocabulary detection models provide strong visual detection but relies on curated prompt formulations and confidence thresholds, which can be unstable in cluttered or edge-case environments.

To address this, the present embodiments can relabel existing coarsely labeled data into more granular, fine-grained categories. Recent advancements in open-source vision-language models (VLMs), object detection, and segmentation networks offer powerful tools for extracting rich semantic information from visual data without extensive supervision. Leveraging these models, the present embodiments can develop scalable pipelines that refine existing labels and generate new ones automatically, dramatically reducing the need for annotation while maintaining high accuracy and consistency. By doing so, the present embodiments reduce the system complexity and computational resource usage (e.g., compute and storage) for training machine learning models with coarsely labeled data.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

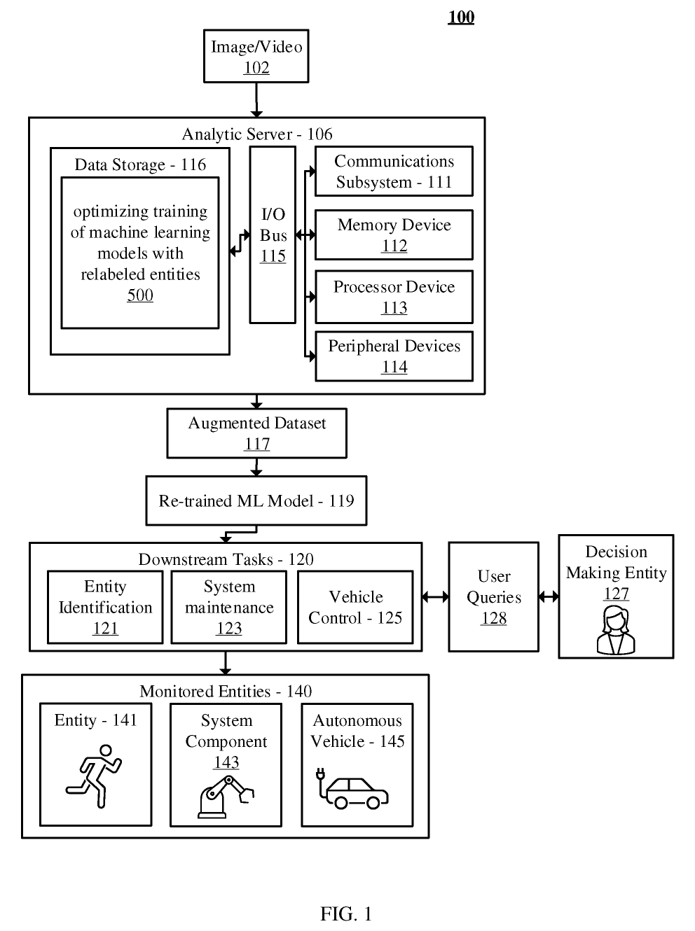

Referring now in detail to the figures in which like numerals represent the same or similar elements and initially to FIG. 1, a block diagram shows a system for optimizing training of machine learning models with relabeled entities, in accordance with an embodiment of the present invention.

In an embodiment using a system 100, monitored entities 140 can include entity 141, system component 143, and autonomous vehicle 145. The monitored entities 140 can generate an input dataset that include image/video 102. The image/video 102 can be transmitted to an analytic server 106 that can implement optimizing training of machine learning models with relabeled entities 500. The analytic server 106 can obtain an augmented dataset 117 with relabeled entities that include fine-grained details that can be utilized to train a machine learning model and obtain a re-trained machine learning model 119. The re-trained machine learning model 119 can be utilized to perform downstream tasks 120.

System 100 can be utilized to perform downstream tasks 120 based on the input dataset 101 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the input dataset 101 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The re-trained machine learning model 119 can predict future attributes, and relationships of the entity 141.

Based on the predictions of the re-trained machine learning model 119, a corrective action can be generated. The corrective action can include notifying the decision making entity 127 of the predictions about the entity 141 based on their input dataset 101, generating resolutions to an issue caused by the entity (e.g., the entity 141 as a disabled vehicle in a traffic scene and the resolution is the deployment of a repair technician, etc.) of the input dataset 101 to help with the decision making process of the decision making entity 127, etc.

In system maintenance 123, input dataset 101 (e.g., system logs, test cases, hardware status images, etc.) related to the system component 143 can be processed to answer user queries 128. The user queries 128 can be relevant on how to properly maintain the system component 143 based on the input dataset 101. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, input dataset 101 (e.g., vehicle part status, traffic scene image, etc.) related to the autonomous vehicle 145 can be processed to answer user queries 128. The user queries 128 can be relevant to how to control the autonomous vehicle 145 given its environment based on the input dataset 101. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the re-trained machine learning model 119.

Other downstream tasks and practical applications are contemplated.

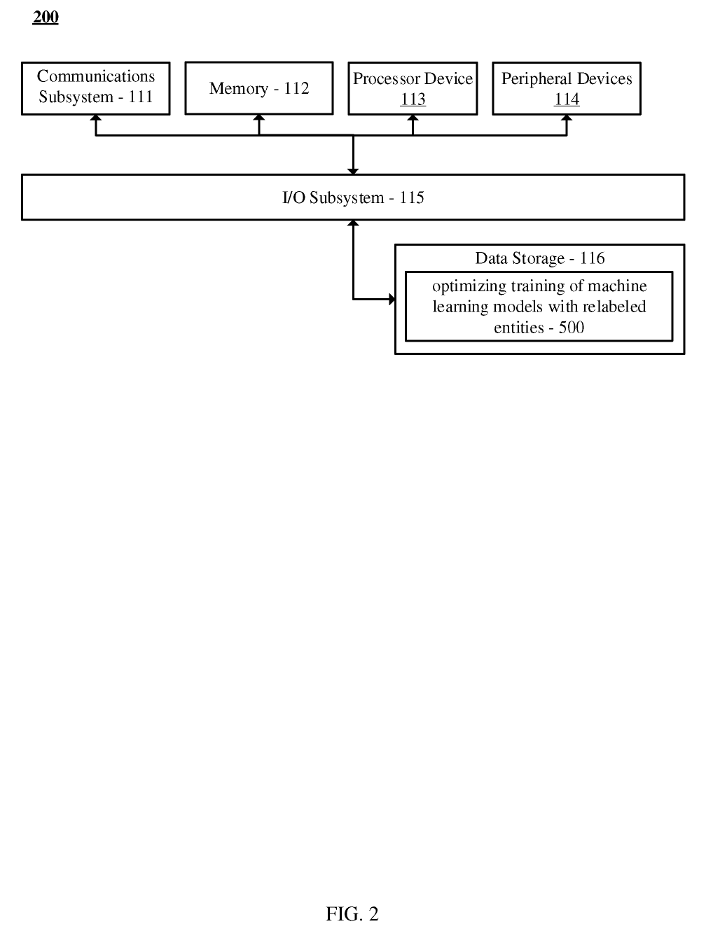

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for optimizing training of machine learning models with relabeled entities, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for optimizing training of machine learning models with relabeled entities 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

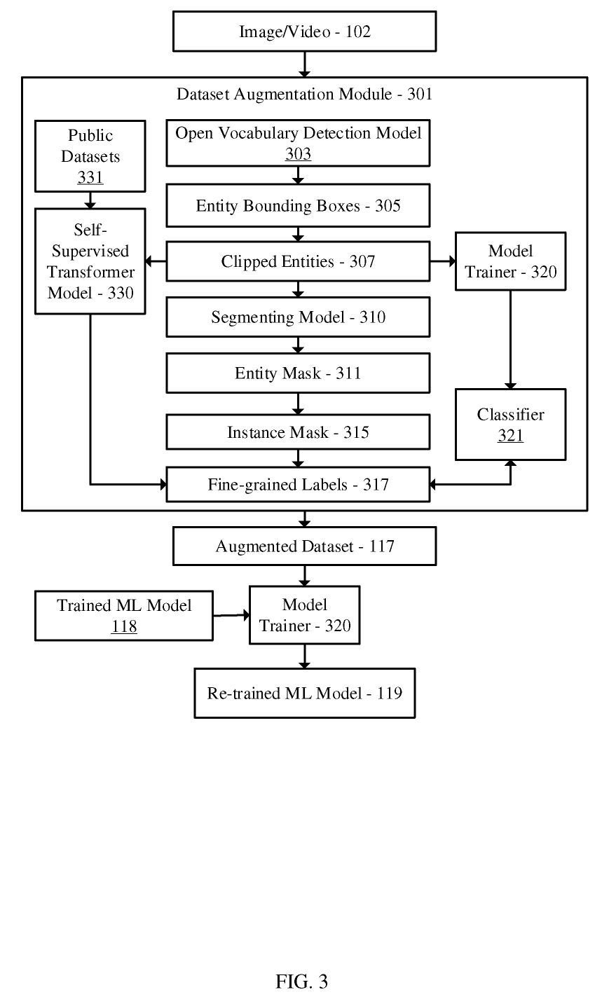

Referring now to FIG. 3, a block diagram shows components of a computer system for optimizing training of machine learning models with relabeled entities, in accordance with an embodiment of the present invention.

In an embodiment, image/video 102 can be processed by a dataset augmentation module 301 to generate an augmented dataset 117. The augmented dataset 117 can be utilized by a model trainer 320 to train a trained ML model 118 and obtain a re-trained ML model 119.

The dataset augmentation module 301 can include an open vocabulary detection mode 303, and a segmenting model 310. The open vocabulary detection model 303 can generate entity bounding boxes 305 from the image/video 102. The entity bounding boxes 305 can be processed to obtain clipped entities 307 which are clippings of the bounding boxes from the image/video 102. The entity bounding boxes 305, clipped entities 307 and the image/video 102 can be processed by the segmenting model 310 to generate entity mask 311. The entity mask 311 for the detected entities can be combined into an instance mask 315. Based on the instance mask 315, the dataset augmentation module 301 can generate fine-grained labels 317 for the detected entities in the image/video 102.

In another embodiment, the entity bounding boxes 305, the clipped entities 307, the entity mask 311, and the instance mask 315 can be utilized by the model trainer 320 to train a classifier 321 with supervised learning to generate instance mask 315 from the image/video 102. The classifier 321 can verify the generated fine-grained labels 317.

In another embodiment, public datasets 331 and the clipped entities 307 can be processed by the self-supervised transformer model 330 to generate the fine-grained labels 317. In an embodiment, the trained ML model 118, the re-trained ML model 119, and the self-supervised transformer model 330 can utilize artificial neural networks.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

In an embodiment, the trained ML model 118 can be trained by minimizing a loss function that compares an output value generated by the trained ML model 118 based on the augmented dataset 117 and training data from the augmented dataset 117.

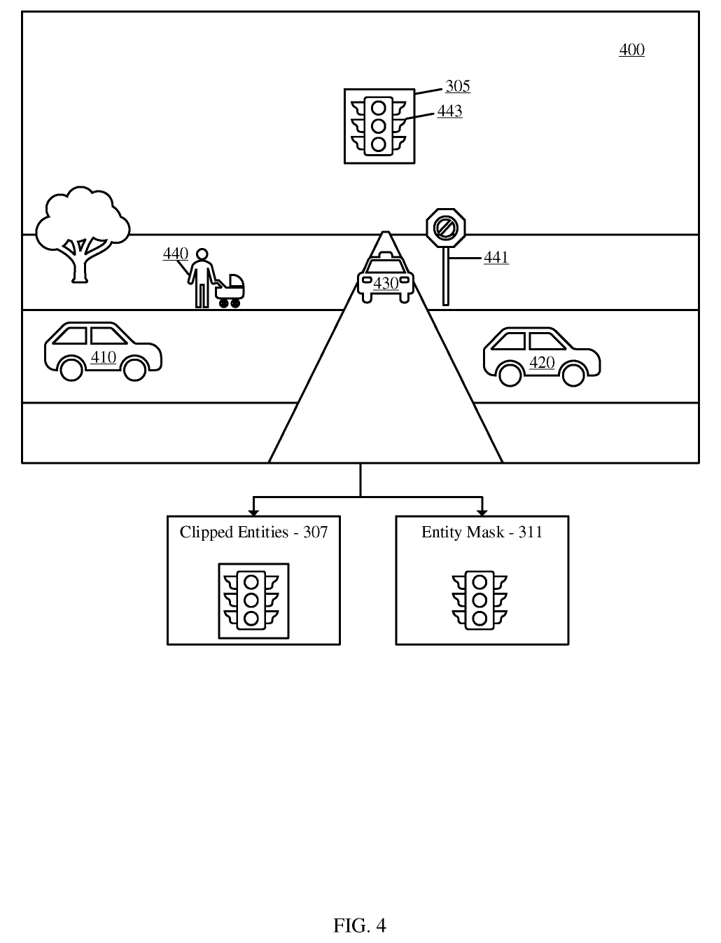

Referring now to FIG. 4, a block diagram shows entities within a scene that are captured with a bounding box, clipped entity, and an entity mask for optimizing training of machine learning models with relabeled entities, in accordance with an embodiment of the present invention.

In an embodiment, a traffic scene 400 can include entities such as a first vehicle 410, a second vehicle 420, a third vehicle 430, a person 440, a traffic sign 441, and a traffic light 443.

Bounding boxes 305 can be generated for the detected entities such as the traffic light 443. The bounding boxes 305 are processed to obtain clipped entities 307 and entity mask 311. The clipped entities 307 are clipped images that result from clipping an image based on the coordinates of the bounding box 305 in the traffic scene 400. The entity mask 311 are segmented images of the detected entity (e.g., traffic light 443). The bounding box 305, clipped entities 307 and entity mask 311 can be utilized to generate the augmented dataset 117.

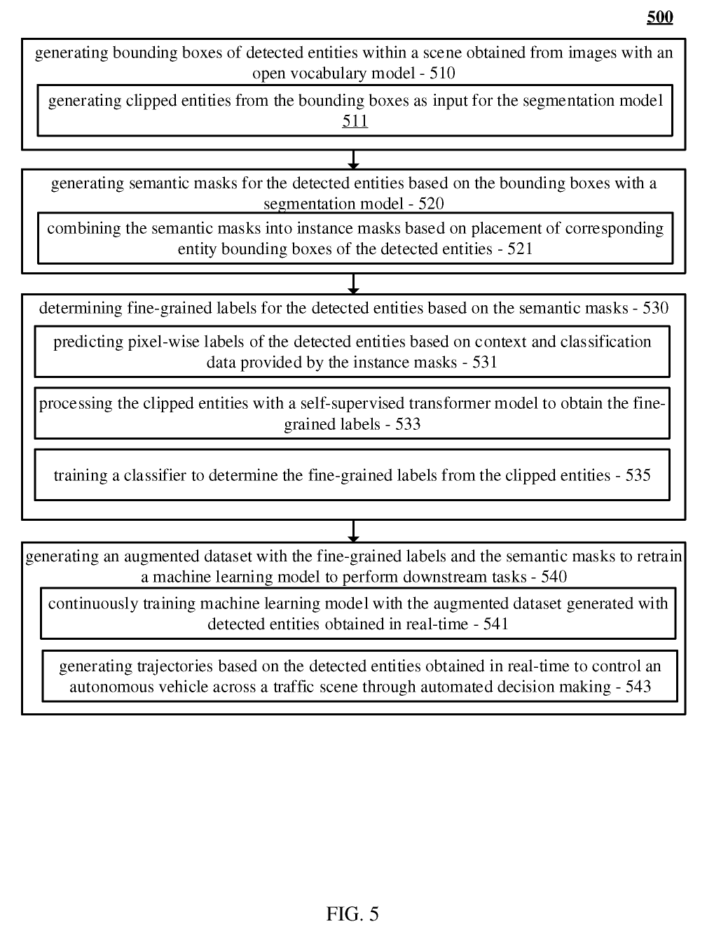

Referring now to FIG. 5, a flow diagram shows a high-level overview of optimizing training of machine learning models with relabeled entities, in accordance with an embodiment of the present invention.

In an embodiment, bounding boxes of detected entities within a scene obtained from images can be generated with an open vocabulary model. Entity masks for the detected entities can be generated based on pixel-wise information of the detected entities obtained within the bounding boxes with a segmentation model. Fine-grained labels for the detected entities can be determined based on filtered pixel-wise information of the detected entities from the entity masks and learned knowledge of fine-grained categories. An augmented dataset can be generated with the fine-grained labels and the entity masks to retrain a machine learning model to perform downstream tasks.

In block 510, bounding boxes of detected entities within a scene obtained from images can be generated by an open-vocabulary model.

In an embodiment, an open-vocabulary detection model 303 can detect entities from the image/video 102 and draw a bounding box around the detected entity and obtain entity bounding boxes 305 within an annotated image. The open-vocabulary detection model 303 can then be utilized to classify the object within the highlighted region from the annotated image and generate an initial label. This allows the open-vocabulary detection model 303 to utilize both the object appearance and its contextual surroundings.

In block 511, clipped entities can be generated from the bounding boxes to obtain classification data for the detected entities.

In an embodiment, for each object instance, the dataset augmentation module 301 can crop the region specified by its bounding box to obtain clipped entities 307. The clipped entities 307 can be utilized by the open vocabulary detection model 303 to classify the entity without any access to surrounding scene context.

In block 520, entity masks for the detected entities can be generated based on pixel-wise information of the detected entities obtained within the bounding boxes with a segmentation model.

In an embodiment, a segmentation model 310 can be utilized on the clipped entities 307 to further improve localization and visual grounding to obtain entity masks 311. The entity masks 311 can be utilized to refine the visual input provided to the open vocabulary detection model 303. This is performed to assess whether pixel accurate segmentation improves the model’s ability to identify fine-grained categories over bounding-box-based approaches.

In block 521, the entity masks can be combined into instance masks based on placement of corresponding entity bounding boxes of the detected entities. By combining the entity masks into instance masks, the context of the detected entities can be learned.

In an embodiment, the open vocabulary detection model 303 and the segmentation model 310 can work in tandem to allow a controlled comparison of how object isolation, context, and segmentation precision influence the classification accuracy across model variants and driving scene distributions.

In block 530, fine-grained labels for the detected entities can be determined based on filtered pixel-wise information of the detected entities from the entity masks and learned knowledge of fine-grained categories.

In an embodiment, in block 531, fine-grained labels 317 can be generated based on filtered pixel-wise information of the detected entities from the entity masks and learned knowledge of fine-grained categories. To obtain filtered pixel-wise information, background pixels or irrelevant pixels can be removed in the entity bounding boxes 305. Learned knowledge of fine-grained categories can be utilized to label the predicted mask which came from entity bounding boxes 305.

In an embodiment, in block 533, the clipped entities can be processed to obtain fine-grained labels with a self-supervised transformer model.

In an embodiment, a self-supervised transformer model 330 can leverage clipped entities 307 to generate fine-grained labels 317. The self-supervised transformer model 330 can compute embeddings for clipped entities 307 obtained from the image/video 102 that can be obtained from a set of open-source datasets containing pre-determined labels for vehicles, pedestrians, and traffic signs. These embeddings are then used within a similarity-based relabeling pipeline: each coarse-labeled object the open-source dataset is matched against the reference feature bank, and its fine-grained category is inferred based on nearest neighbor retrieval or cosine similarity ranking.

The self-supervised transformer model 330 provides an efficient and scalable method to map coarse labels to more specific categories without relying on textual prompts or supervised fine-tuning. The self-supervised transformer model 330 provides a visual-only baseline and offers robust performance, especially in cases where textual ambiguity limits the effectiveness of language-driven models.

In block 535, a classifier can be trained with supervised learning to generate the fine-grained labels from clipped entities.

In an embodiment, the classifier 321 can be trained with supervised learning to generate and verify the fine-grained labels 317 from the clipped entities. The classifier 321 can utilize a residual network (ResNet)-based framework and can be trained on curated subsets of publicly available datasets that contain fine-grained annotations for categories such as vehicles, pedestrians, and traffic signs.

During inference, the provided coarse category (e.g., traffic sign, vehicle ) can be utilized to identify the relevant subclass space. The clipped entities 307 can be passed to the classifier 321 to predict the most likely fine-grained label 317. This coarse-to-fine classification strategy allows for a controlled label search space, improving reliability and interpretability. The fine-grained labels 317 generated by the self-supervised transformer model 330 and the tandem of the open vocabulary detection model 303 and the segmenting model 310 can be compared with the fine-grained label 317 generated by the classifier 321.

In an embodiment, the comparison can be performed based on the similarity of the fine-grained labels 317 and the accuracy score of the fine-grained labels 317. The fine-grained label 317 having the higher accuracy score can be utilized to relabel the corresponding label for a detected entity for the augmented dataset 117. This also improves the interpretability of the generated fine-grained labels 317 as more details about the generation process can be provided.

In block 540, an augmented dataset can be generated based on the fine-grained labels and the entity masks to retrain a machine learning model to perform downstream tasks.

In an embodiment, the past labels of the detected entities can be replaced with the fine-grained labels 317 to generate an augmented dataset 117. For example, for a detected entity for a traffic light having an initial label of “traffic light” can be replaced with a fine-grained label 317 “traffic light showing a red light.”

In block 541, the trained machine learning model can be continuously trained with the augmented dataset generated with detected entities obtained in real-time.

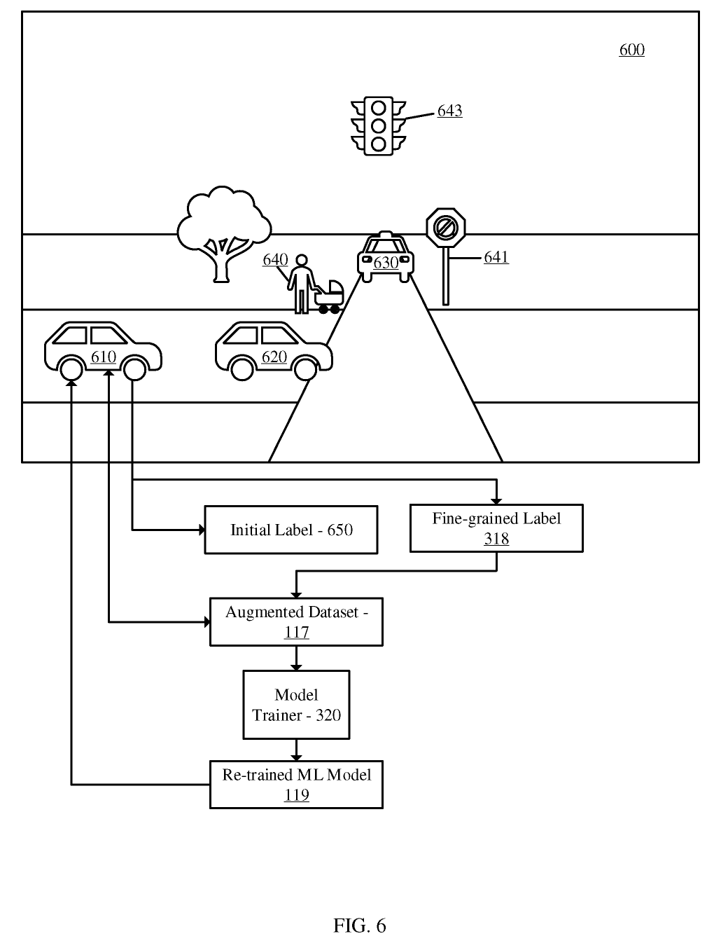

In block 543, trajectories based on the detected entities obtained in real-time can be generated to control an autonomous vehicle across a traffic scene through automated decision-making. Blocks 541 and 543 are shown more in detail in FIG. 6.

Referring now to FIG. 6, a block diagram shows a practical application involving autonomous vehicles for optimizing training of machine learning models with relabeled entities, in accordance with an embodiment of the present invention.

In an embodiment, in traffic scene 600, vehicle 610 can communicate with analytic server 106 through a network. User queries 128 can be communicated to vehicle 610 through an artificial intelligence (AI) agent that can communicate with the analytic server 106. The user queries 128 can include commands to control vehicle 610 such as controlling the components of the vehicle (e.g., air quality control, entertainment components such as radio, etc.) and controlling the trajectory of the vehicle (e.g., speeding up, braking, change direction, etc.) through autonomous decision making.

Vehicle 610 can autonomously understand the traffic scene 600 and generate augmented dataset 117 based on the traffic scene. The augmented dataset 117 can include fine-grained label 318 that relabels initial label 650 obtained by the trained machine learning model 118 utilized by the vehicle 610. The augmented dataset 117 can be utilized by the model trainer 320 to train the trained machine learning model 118 and obtain re-trained ML model 119. In another embodiment, the trained machine learning model 118 can be trained continuously with the augmented dataset 117 generated in real-time.

The re-trained ML model 119 can generate predictions of trajectories of the entities in the traffic scene 600. For example, the trajectories can include the following: “it is safe to cross the intersection and overtake vehicle (620) that is in the intersection as pedestrian (640) is crossing parallel to the intersection and taxi (630) is stopped behind one-way sign (641) as the light on (643) is red for taxi (630) and green for vehicle (620).”

In another embodiment, in traffic scene 600, vehicle 610 can simulate trajectories for the identified entities. In another embodiment, in traffic scene 600, based on the simulated trajectories of the identified entities, vehicle 610 can generate a trajectory to avoid the simulated trajectories of the identified entities and avoid collisions. In another embodiment, the vehicle 610 can be autonomously controlled based on the generated trajectory to avoid collisions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
generating bounding boxes of detected entities within a scene obtained from images with an open vocabulary model;
generating entity masks for the detected entities based on pixel-wise information of the detected entities obtained within the bounding boxes with a segmentation model;
determining fine-grained labels for the detected entities based on filtered pixel-wise information of the detected entities from the entity masks and learned knowledge of fine-grained categories; and
generating an augmented dataset with the fine-grained labels and the entity masks to retrain a machine learning model to perform downstream tasks.

2. The method of claim 1, further comprising generating clipped entities from the bounding boxes as input for the segmentation model.

3. The method of claim 1, wherein generating the entity masks further comprises combining the entity masks into instance masks based on placement of corresponding bounding boxes of the detected entities.

4. The method of claim 3, wherein generating the fine-grained labels further comprises predicting pixel-wise labels of the detected entities based on context and classification data provided by the instance masks.

5. The method of claim 2, further comprising training a classifier to determine the fine-grained labels from the clipped entities.

6. The method of claim 1, further comprising continuously training machine learning model with the augmented dataset generated with detected entities obtained in real-time.

7. The method of claim 1, further comprising generating trajectories based on detected entities obtained in real-time to control an autonomous vehicle across a traffic scene through automated decision making.

8. A system, comprising:
a memory device;
one or more processor devices operatively coupled with the memory device to perform operations including:
generating bounding boxes of detected entities within a scene obtained from images with an open vocabulary model;
generating entity masks for the detected entities based on pixel-wise information of the detected entities obtained within the bounding boxes with a segmentation model;
determining fine-grained labels for the detected entities based on filtered pixel-wise information of the detected entities from the entity masks and learned knowledge of fine-grained categories; and
generating an augmented dataset with the fine-grained labels and the entity masks to retrain a machine learning model to perform downstream tasks.

9. The system of claim 8, further comprising generating clipped entities from the bounding boxes as input for the segmentation model.

10. The system of claim 8, wherein generating the entity masks further comprises combining the entity masks into instance masks based on placement of corresponding bounding boxes of the detected entities.

11. The system of claim 10, wherein generating the fine-grained labels further comprises predicting pixel-wise labels of the detected entities based on context and classification data provided by the instance masks.

12. The system of claim 9, further comprising training a classifier to determine the fine-grained labels from the clipped entities.

13. The system of claim 8, further comprising continuously training machine learning model with the augmented dataset generated with detected entities obtained in real-time.

14. The system of claim 8, further comprising generating trajectories based on detected entities obtained in real-time to control an autonomous vehicle across a traffic scene through automated decision making.

15. A non-transitory computer program product comprising a computer-readable storage medium including a program code, wherein the program code when executed on a computer causes the computer to perform operations including:
generating bounding boxes of detected entities within a scene obtained from images with an open vocabulary model;
generating entity masks for the detected entities based on pixel-wise information of the detected entities obtained within the bounding boxes with a segmentation model;
determining fine-grained labels for the detected entities based on filtered pixel-wise information of the detected entities from the entity masks and learned knowledge of fine-grained categories; and
generating an augmented dataset with the fine-grained labels and the entity masks to retrain a machine learning model to perform downstream tasks.

16. The non-transitory computer program product of claim 15, further comprising generating clipped entities from the bounding boxes as input for the segmentation model.

17. The non-transitory computer program product of claim 15, wherein generating the entity masks further comprises combining the entity masks into instance masks based on placement of corresponding bounding boxes of the detected entities.

18. The non-transitory computer program product of claim 17, wherein generating the fine-grained labels further comprises predicting pixel-wise labels of the detected entities based on context and classification data provided by the instance masks.

19. The non-transitory computer program product of claim 16, further comprising training a classifier to determine the fine-grained labels from the clipped entities.

20. The non-transitory computer program product of claim 15, further comprising generating trajectories based on detected entities obtained in real-time to control an autonomous vehicle across a traffic scene through automated decision making.
